(19) United States
(12) Patent Application Publication
(10) Pub. No.: US 2024/0087012 A1
(43) Pub. Date: Mar. 14, 2024

(54) System and Method of Optimizing an Automated Vendor Assignment Process for Mortgage Professionals

(71) Applicant: Vladimir Bien-Aime, Conshohocken, PA (US)

(72) Inventor: Vladimir Bien-Aime, Conshohocken, PA (US)

(21) Appl. No.: 18/367,447

(22) Filed: Sep. 12, 2023

Related U.S. Application Data
(60) Provisional application No. 63/405,791, filed on Sep. 12, 2022.

(51) Int. Cl. G06Q 40/03; G06Q 50/16

(52) U.S. Cl. CPC G06Q 40/03; G06Q 50/16

(57) ABSTRACT

A system and a method of optimizing an automated vendor assignment process for mortgage professionals automates the process without development intervention so users can self-manage and customize the process. An overall process of the method begins by receiving an order request from a lender account. The lender account is then prompted to select a specific exclusion rule from several exclusion rules. The specific exclusion rule is appended into the order request, if a specific exclusion rule is selected. The lender account is also prompted to select a specific vendor filter from several vendor filters. The specific vendor filter is appended into the order request, if a specific vendor filter is selected. The order request is then relayed to a remote server so that the order request can be compared to each vendor profile to identify a matching vendor profile. The matching vendor profile is finally assigned to the order request.

The current application claims a priority to the U.S. provisional patent application Ser. No. 63/405,791 filed on Sep. 12, 2022.

### FIELD OF THE INVENTION

The present invention relates generally to loan and mortgage systems. More specifically, the present invention provides means to automate and optimize the vendor assignment process for mortgage professionals.

### BACKGROUND OF THE INVENTION

Appraisal management software has become an important aspect of the mortgage lending industry that enables mortgage lenders to order real estate valuation services. In general, appraisal management software automates the administrative functions of the appraisal process including, but not limited to, selecting an appropriate appraiser, and delivering the appraisal report to the mortgage lender. This is an important process since it requires the management of multidisciplinary appraisal practices to maintain regulatory compliance. For example, the United States government imposed several appraiser independence guidelines to restrict the influence of mortgage lenders on the appraisers. However, existing products are antiquated and can hinder efficiency in the process. For example, most existing products are not customizable, which forces the mortgage lender to depend on the product provider to implement desired changes, such as customizing rules and processes that fit the mortgage lender's specific needs. Further, most existing products still require user involvement that includes routine tasks that are time-consuming. Therefore, there is a need for a more efficient product that optimizes the process for vendor assignment while catering to the mortgage lender's specific needs and meeting regulatory compliance.

An objective of the present invention is to provide a system and method of optimizing an automated vendor assignment process for mortgage professionals that automates every desired activity within the appraisal ordering process. The present invention enables designated users to create new fields for any action that is needed instantaneously, and the fields are immediately usable and reportable. Another objective of the present invention is to facilitate the automation of routine tasks in the appraisal ordering process while keeping everything reportable and trackable. Another objective of the present invention is to facilitate the customization of the appraisal ordering process to allow the creation of specific rule sets that optimize the selection of the appraiser vendor that best fit the mortgage lender's specific needs. Another objective of the present invention is to provide a method that enables the auto-assignment of different mortgage-related services to different available vendors. Additional features and benefits of the present invention are further discussed in the sections below.

### SUMMARY OF THE INVENTION

The present invention provides a system and a method of optimizing an automated vendor assignment process for mortgage professionals. The present invention enables mortgage lenders to request a mortgage-related service from an appropriate vendor without having staff manually assigning orders to the appropriate vendor. The present invention implements all or some of the admissible approaches typically associated with manual human-based assignment decision logic while automating the process with a flexible algorithm that improves over time. Further, the present invention provides a customizable ordering process that enables staff to consistently select the most optimal vendors based on corporate policy and best practices.

In general, the method of the present invention includes the steps of applying auto-assign filters to determine potential vendors for the mortgage-related order. The potential vendors are then verified to determine if the potential vendors can complete the ordered service and are eligible for auto-assignment. Then, the service due date is calculated if configured, and the service due date is verified that is a real future date. The potential vendors' eligibility is determined based on several parameters including, but not limited to, geographical location, service type, exclusion reasons, custom rules set, auto-assignment status, etc. Then, the eligible vendors are ranked to determine the most eligible vendor that gets the service order auto-assigned to. If the order assignment fails for any reason (e.g., the vendor declining the order), the auto-assignment process is cycled through the eligible vendors so that the next best vendor option is selected. Then, the vendor fee is assigned for service and the vendor specific engagement letter is generated (e.g., contract and instructions for service performed).

### BRIEF DESCRIPTION OF THE DRAWINGS

FIG. 1 is a block diagram showing the system of the present invention.

FIG. 2 is a flowchart showing an overall method of the present invention.

FIG. 3 is a flowchart showing a continuation of FIG. 2.

FIG. 4 is a flowchart showing the subprocess of auto-selecting the best available service vendor from several matching vendor profiles.

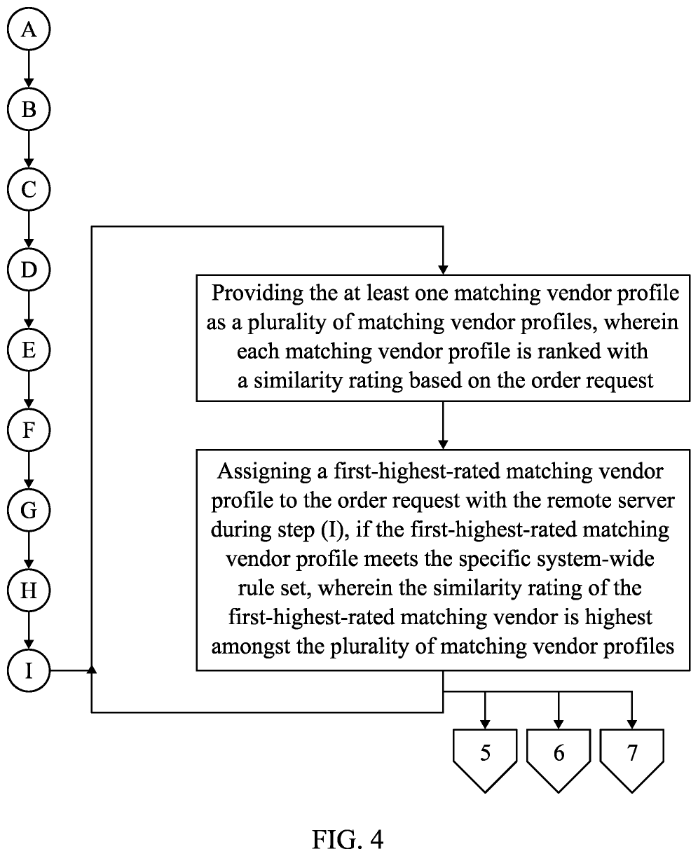

FIG. 5 is a flowchart showing the subprocess of triggering the auto-reassignment due to a vendor declination.

FIG. 6 is a flowchart showing the subprocess of triggering the auto-reassignment due to a lender declination.

FIG. 7 is a flowchart showing the subprocess of overriding the auto-reassignment subprocess.

FIG. 8 is a flowchart showing the subprocess of filtering the vendors using exclusion rules and vendor filters.

FIG. 9 is a flowchart showing the subprocess of customizing the system-wide rule sets.

### DETAIL DESCRIPTIONS OF THE INVENTION

All illustrations of the drawings are for the purpose of describing selected versions of the present invention and are not intended to limit the scope of the present invention.

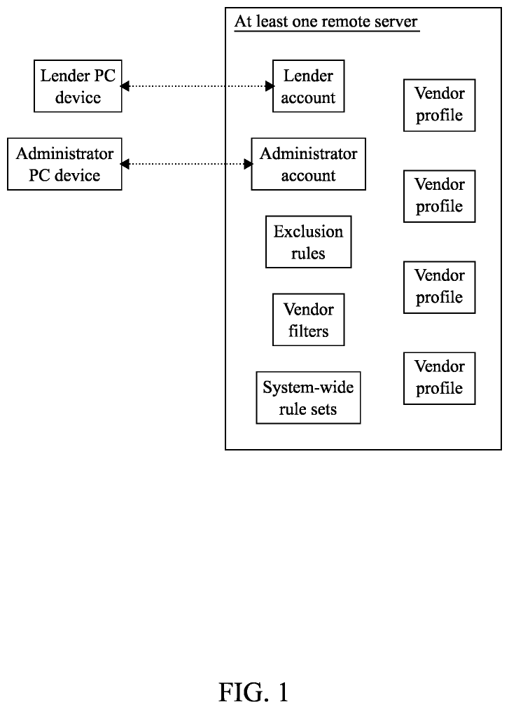

The present invention includes a system and a method of optimizing an automated vendor assignment process for mortgage professionals. The present invention provides a completely configurable platform that automates the vendor assignment process without development intervention while enabling users to manage and customize the process according to the users' specific needs. As can be seen in FIG. 1, the system of the present invention includes at least one lender account managed by at least one remote server (Step A). The lender account enables authorized users to access the different features provided by the present invention to perform the automated vendor assignment process. In addition, the lender account is associated with a corresponding lender personal computing (PC) device that enables authorized users to access the platform of the present invention. The corresponding lender PC device may be any type of computing device such as, but not limited to, a desktop computer, a notebook computer, a smartphone, or a mobile tablet. The remote server is used as a hub to exchange and manage information related to the automated assignment process of the service order to the most appropriate service vendor. Further, the remote server stores a plurality of vendor profiles, a plurality of exclusion rules, a plurality of vendor filters, and a plurality of system-wide rule sets. The plurality of vendor profiles includes information about available service vendors that can be used to perform specific services for the mortgage lender. The plurality of exclusion rules enables the user to remove potential vendors that match undesired user criteria. The plurality of vendor filters enables the user to filter out vendors that do not meet desired user criteria. The plurality of system-wide rule sets establishes the lender's set criteria that all the vendor assignments must follow.

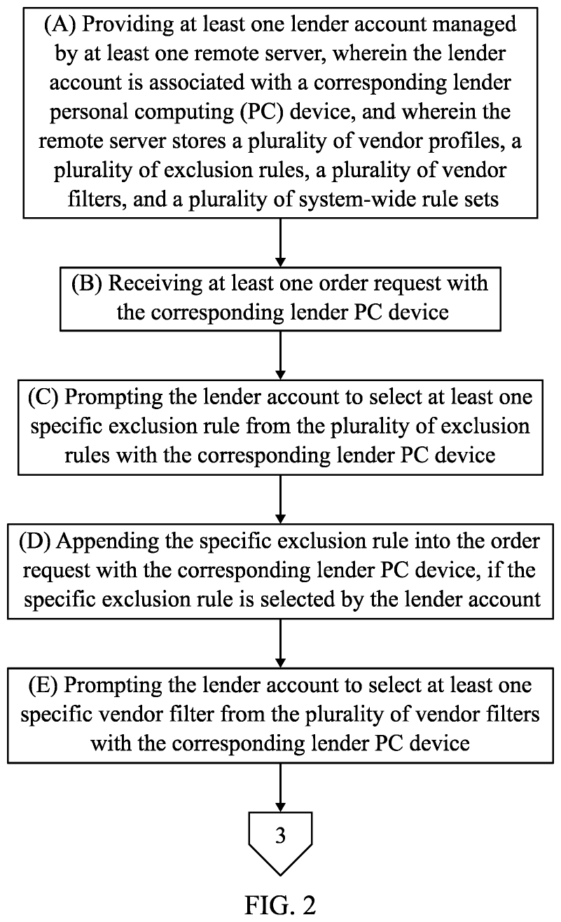

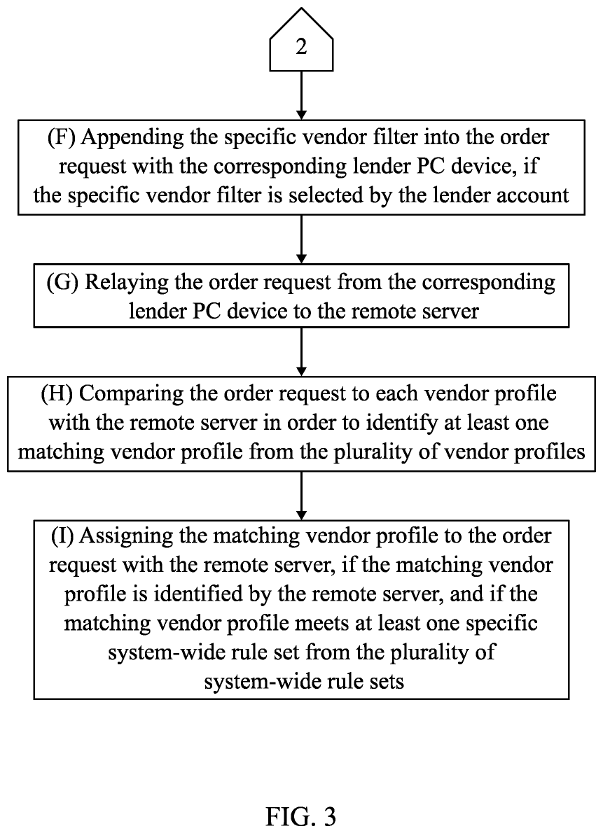

The method of the present invention follows an overall process that maximizes staff efficiency and reduces costs by simplifying competitive bidding through an automated workflow method. As can be seen in FIGS. 2 and 3, the overall process begins by receiving at least one order request with the corresponding lender PC device (Step B). The order request includes all information regarding the service that needs to be assigned to an appropriate vendor. The platform of the present invention facilitates the creation and submittal of an order request by enabling the quick upload of the appropriate documentation to the platform via a software application. The software application can be accessed on the corresponding lender PC device and is developed to be compatible with the corresponding lender PC device. For example, the software application can be provided as a desktop application for a desktop computer or laptop, as a mobile application for mobile computing device, etc. Further, the lender account is prompted to select at least one specific exclusion rule from the plurality of exclusion rules with the corresponding lender PC device (Step C). Each of the plurality of exclusion rules prevents at least one specific available vendor from being automatically assigned to the order request. For example, the exclusion rules can include, but are not limited to, exclusions based on the mortgage lender's profile, available vendor's status, services, etc. Further, the specific exclusion rule is appended into the order request with the corresponding lender PC device, if the specific exclusion rule is selected by the lender account (Step D). The selection of a desired exclusion rule needs to be done prior to the submission of the order request so that the order request with all of its stipulations can be processed at the same time by the remote server. Similar to the exclusion rules, the lender account is prompted to select at least one specific vendor filter from the plurality of vendor filters with the corresponding lender PC device (Step E). The vendor filters further improve the selection of the best available vendor by filtering available vendors according to the target geographic location, matching services, real estate type, availability, etc. Likewise, the specific vendor filter is appended into the order request with the corresponding lender PC device, if the specific vendor filter is selected by the lender account (Step F). The selection of a desired vendor filter needs to also be done prior to the submission of the order request so that the order request with all of its stipulations can similarly be processed at the same time by the remote server.

As can be seen in FIGS. 2 and 3 the overall process continues by relaying the order request from the corresponding lender PC device to the remote server (Step G). The remote server then processes the order request by comparing the order request to each vendor profile in order to identify at least one matching vendor profile from the plurality of vendor profiles (Step H). The comparison is performed using the predetermined exclusion rules and vendor filters stored on the remote server. If the authorized user customized the exclusion rules and/or the vendor filters, the changes are updated in real-time on the remote server so that the order request is processed accordingly. The overall process concludes by assigning the matching vendor profile to the order request with the remote server (Step I), if the matching vendor profile is identified by the remote server, and if the matching vendor profile meets at least one specific system-wide rule set from the plurality of system-wide rule sets. The system-wide rule sets include one or more user-defined custom logic cascade that determines the best available vendor for the order request based on a global configuration or service-specific configurations. Each system-wide rule set can include set criteria and filters that are customizable by authorized users. Once the matching vendor profile is determined, the vendor fee is assigned for service, and the vendor specific engagement letter is generated, which can include, but is not limited to, service contract, instructions for service performed, etc. Thus, the order request is automatically assigned to the best choice of available service vendors in a prompt manner.

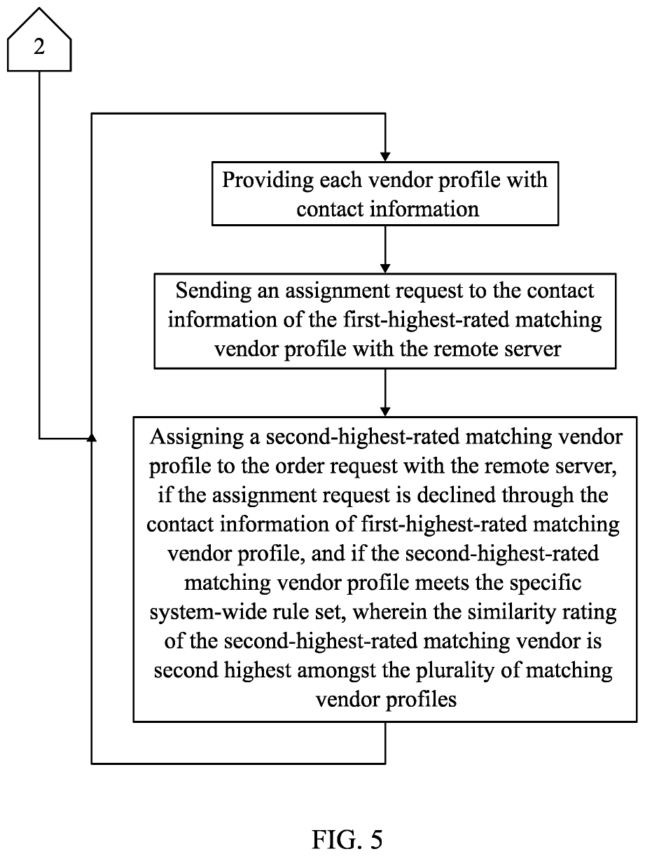

As discussed, the assignment process is automated to optimize and streamline the process. The automation can be implemented with machine learning technologies so that the assignment process improves over time. This is critical for the assignment process so that the matching vendor profile is the best option for the order request since several vendor profiles can be determined by the remote server as good options for the order request. A plurality of matching profiles can be determined by the remote server when each matching vendor profile is ranked with a similarity rating based on the order request. For example, the similarity rating can be a weighted score corresponding to how much the specific vendor profile matches the user's and mortgage lender's criteria. As can be seen in FIG. 5, the subprocess of auto-selecting the best available service vendor from several matching vendor profiles includes the following step. To ensure that the best vendor for the order request is auto-assigned, a first-highest-rated matching vendor profile is assigned to the order request with the remote server during Step I, if the first-highest-rated matching vendor profile is determined if the matching vendor profile meets the specific system-wide rule set, and if the similarity rating of the first-highest-rated matching vendor is highest amongst the plurality of matching vendor profiles. This way, the auto-assigned vendor is the chosen from the best candidates by ensuring that the auto-assigned vendor's profile meets the most of criteria set by the mortgage lender as compared to the other vendor candidates.

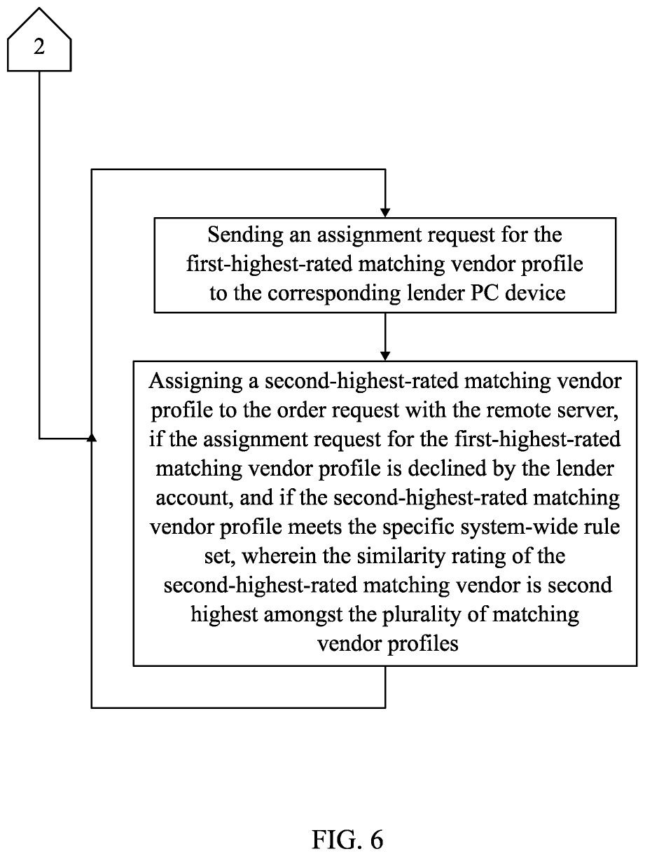

The vendor specific engagement letter is automatically generated and sent to the selected vendor by the present invention to streamline the vendor assignment process. To do so, each vendor profile is provided with contact information so that the proper order request documentation can be sent to the vendor. The contact information can include, but is not limited to, information about the available methods of contacting the vendor such as email address, phone number, etc. As can be seen in FIG. 6, the subprocess of triggering the auto-reassignment due to a vendor declination includes the following steps. After the first-highest-rated matching vendor profile is determined, an assignment request is sent to the contact information of the first-highest-rated matching vendor profile with the remote server. This allows the assigned vendor to receive the order request and perform the requested services. However, the assigned vendor may decide to decline the order request or submit different terms for the order request. A second-highest-rated matching vendor profile is instead assigned to the order request with the remote server, if the assignment request is declined through the contact information of first-highest-rated matching vendor profile, and if the second-highest-rated matching vendor profile meets the specific system-wide rule set, wherein the similarity rating of the second-highest-rated matching vendor is second highest amongst the plurality of matching vendor profiles so that the order request can be fulfilled in a prompt manner. The similarity rating of the second-highest-rated matching vendor is second highest amongst the plurality of matching vendor profiles. This enables the present invention to auto-reassign the order request to the next best service vendor, if necessary, without requiring manual intervention of the authorized users of the mortgage lender.

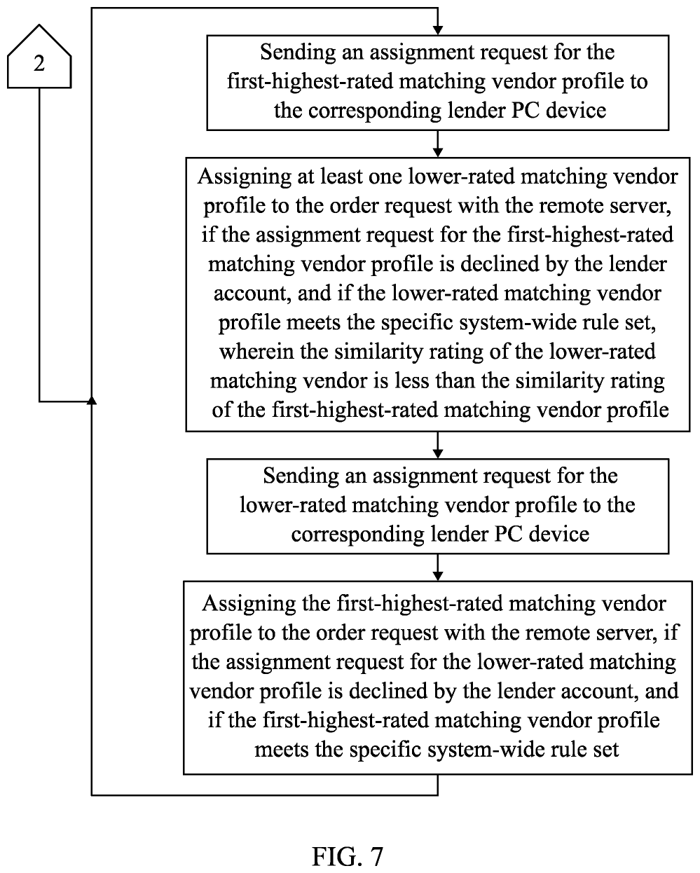

The auto-reassignment process can also be performed if the user (i.e., a lender using the present invention) decides to not use the service vendor auto-selected by the present invention. As previously discussed, the present invention keeps the authorized users updated throughout the process. For example, the authorized user can be notified of the assignment request once the present invention auto-selects the best service vendor. As can be seen in FIG. 7, the subprocess of triggering the auto-reassignment due to a lender declination includes the steps of sending an assignment request for the first-highest-rated matching vendor profile to the corresponding lender PC device to notify the authorized user that the present invention has determined the best service vendor for the order request. Then, a second-highest-rated matching vendor profile is assigned to the order request with the remote server, if the assignment request for the first-highest-rated matching vendor profile is declined by the lender account, and if the second-highest-rated matching vendor profile meets the specific system-wide rule set. Likewise the similarity rating of the second-highest-rated matching vendor is second highest amongst the plurality of matching vendor profiles. This way, the next best option for service vendor is automatically selected by the present invention without involving direct input from the authorized users of the mortgage lender.

The auto-reassignment process further automates the vendor assignment process and can be controlled by implementing auto-reassignment rules that ensure the automated process follows the mortgage lender's needs. The auto-reassignment rules can include, but are not limited to, a maximum number of attempts, maximum number of order request acceptances with conditions, maximum number of order request declines by vendors, etc. Further, the auto-reassignment process can also be triggered by pre-established time limit that the selected vendor has to accept the assignment request. This way, the auto-reassignment rules enable the present invention to continue the auto-reassignment process until a suitable available vendor is determined and assigned. However, to prevent the automated process from continuing indefinitely without successfully assigning an appropriate service vendor, the method of the present invention can further implement an override subprocess. The override subprocess forces the auto-assignment of the order request to the first-highest-rated matching vendor after certain predetermined conditions are met. For example, if the auto-assignment process takes too long, the override subprocess can be triggered so that the service order can be carried out by the first-highest-rated matching vendor. This also ensures that order requests are assigned even if the selected service vendors keep declining the assignment requests so that the order request is carried out in a timely manner.

As can be seen in FIG. 7, the overriding subprocess begins by sending an assignment request for the first-highest-rated matching vendor profile to the corresponding lender PC device. This enables the authorized users to stay updated on the first choice of available service vendors. Then, at least one lower-rated matching vendor profile is assigned to the order request with the remote server, if the assignment request for the first-highest-rated matching vendor profile is declined by the lender account or by the corresponding service vendor, and if the lower-rated matching vendor profile meets the specific system-wide rule set. Moreover, the similarity rating of the lower-rated matching vendor is less than the similarity rating of the first-highest-rated matching vendor profile. This ensures that the next selections are still appropriate for the order request. Likewise, an assignment request for the lower-rated matching vendor profile is sent to the corresponding lender PC device to update the authorized users on the auto-reassignment subprocess. After the override thresholds are passed, the first-highest-rated matching vendor profile is assigned again to the order request with the remote server, if the assignment request for the lower-rated matching vendor profile is declined by the lender account, and if the first-highest-rated matching vendor profile still meets the specific system-wide rule se. Thus, the present invention ensures that the order request is auto assigned on a timely basis so that the necessary services are carried out by the best available service provider.

As previously discussed, the present invention provides greater customization capabilities to ensure that the current mortgage lender's needs are always considered when the auto-assignment process is performed. For example, the exclusion rules can include several preferences including, but not limited to, lender-profile preferences, vendor status preferences, and service-related preferences. The lender profile preferences can include, but are not limited to, licensing eligibility, insurance eligibility, background check requirements, minimum scoring, minimum capacity, minimum experience, availability, coverage type, capacity, loan types, loan values, and property types. The vendor status preferences can include, but are not limited to, new vendors, vendors pending review, vendors on a watch list, vendors on a Do-Not-Use (DNU) list, and vendors with incomplete profiles. The service-related preferences can include, but are not limited to, previously assigned vendors, vendors on a global DNU list, vendors on an investors DNU list, and vendors on Not-on-Office approved list. Furthermore, the vendor filters can include several filters that can readily be chosen by the authorized user. For example, the vendor filters can include, but are not limited to, location filters and vendor-service filters. The location filters enable the selection of available vendors on target geographic locations. The vendor-service filters are vendor-related to enable the selection of vendors according to the services the vendors provide, the property type of the order request that vendors can service, and the availability of the vendors. In other embodiments, additional exclusion rules and filters can be implemented so that the present invention can cater to the mortgage lender's needs.

Likewise, the system-wide rule sets include several rule set filters and rule set criteria that can be chosen from to enable the authorized users to establish specific rule sets that are globally applied when auto-selecting the best service provided for the order request. For example, the rule set criteria can include, but is not limited to, appraiser designations, closest proximity, coverage type, daily services range, distance, errors and omissions insurance coverage, time experience, general liability coverage, highest vendor rank, license type, lowest vendor fee, open services range, quickest turn time, vendor fee range, vendor rank, vendor score, and vendor type. The vendor score can be weighted using a weighted scoring model that utilizes four factors such as an in-house automated residential appraisal review, turn time, reviewer quality score, and revision count (i.e., resubmission because of errors). The vendor types can include, but are not limited to, individual vendor, regional company, and national outsource entity. Further, the rule set criteria can be ranked in a specific order if desired. Likewise, the rule set filters can include several options that the authorized user can choose from to generate custom assign rules. For example, the rule set filters can include, but is not limited to, service category (e.g., commercial, commercial data product, residential, residential data product, etc.), service, loan amount, purpose, and/or type, purchase price, estimated value, Loan to Value ratio (LTV %), branch, state, vendor, vendor type, vendor status, broker, investor in the secondary mortgage market, reviewer, reviewer type, assignment type, review decision, in-house score, appraisal value, collateral underwriter score, and loan collateral advisor risk score. In other embodiments, different rule set criteria and rule set filters can be implemented to further customize the system-wide rule sets utilized during the auto-assignment process.

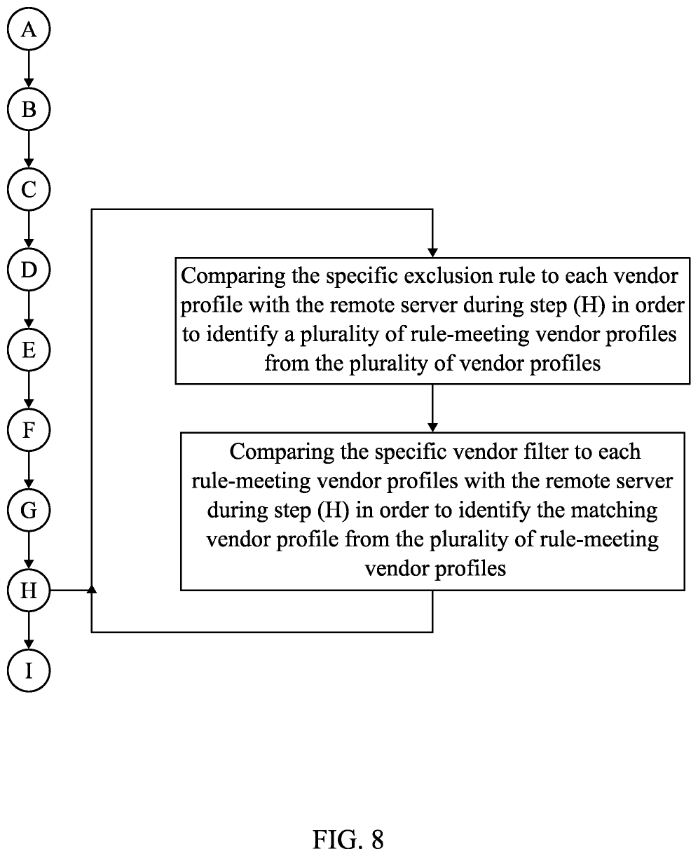

The exclusion rules and the vendor filters enable the quick processing of the order request by removing vendors that would not be a good choice to perform the requested services. As can be seen in FIG. 8, the subprocess of filtering the vendors using exclusion rules and vendor filters includes the steps of comparing the specific exclusion rule to each vendor profile with the remote server during Step H in order to identify a plurality of rule-meeting vendor profiles from the plurality of vendor profiles. In other words, the present invention determines matching vendors by removing vendors according to the exclusion rules. Further, the specific vendor filter is compared to each rule-meeting vendor profiles with the remote server during Step H in order to identify the matching vendor profile from the plurality of rule-meeting vendor profiles. This way, the vendors pool stored in the remote server is filtered to determine the matching vendors that are good choices to perform the service request.

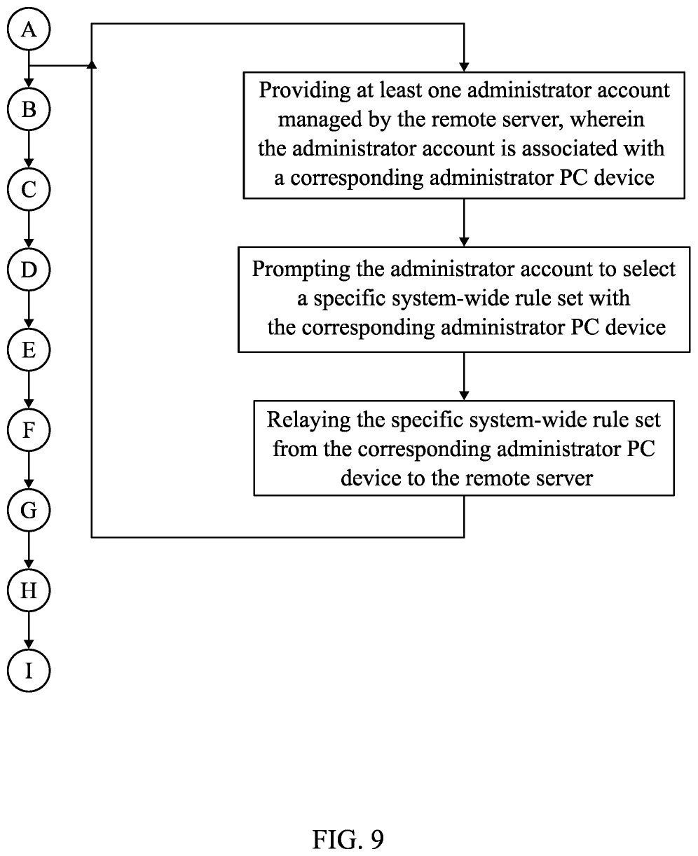

Further, the present invention includes user-role based capabilities that ensure every user can only access the corresponding material at the predetermined times. For example, the system-wide rule sets can be customized by authorized users when necessary. At least one administrator account managed can be provided that is managed by the remote server that can perform administrator level functions. Similar to the lender account, the administrator account is associated with a corresponding administrator PC device that enables the authorized user to perform the different administrator functions. The corresponding administrator PC device may be any type of computing device such as, but not limited to, a desktop computer, a notebook computer, a smartphone, or a mobile tablet. As can be seen in FIG. 9, the subprocess of customizing the system-wide rule sets includes the steps of prompting the administrator account to select a specific system-wide rule set with the corresponding administrator PC device to be used during the auto-assignment process. Then, the specific system-wide rule set is relayed from the corresponding administrator PC device to the remote server so that the present invention utilizes the chosen rule set to auto-select the best service vendor. In other embodiments, additional administrative functions can be provided that enable authorized users to perform certain tasks.

Although the invention has been explained in relation to its preferred embodiment, it is to be understood that many other possible modifications and variations can be made without departing from the spirit and scope of the invention.

What is claimed is:

1. A method of optimizing an automated vendor assignment process for mortgage professionals, the method comprising the steps of:
(A) providing at least one lender account managed by at least one remote server, wherein the lender account is associated with a corresponding lender personal computing (PC) device, and wherein the remote server stores a plurality of vendor profiles, a plurality of exclusion rules, a plurality of vendor filters, and a plurality of system-wide rule sets;
(B) receiving at least one order request with the corresponding lender PC device;
(C) prompting the lender account to select at least one specific exclusion rule from the plurality of exclusion rules with the corresponding lender PC device;
(D) appending the specific exclusion rule into the order request with the corresponding lender PC device, if the specific exclusion rule is selected by the lender account;
(E) prompting the lender account to select at least one specific vendor filter from the plurality of vendor filters with the corresponding lender PC device;
(F) appending the specific vendor filter into the order request with the corresponding lender PC device, if the specific vendor filter is selected by the lender account;
(G) relaying the order request from the corresponding lender PC device to the remote server;
(H) comparing the order request to each vendor profile with the remote server in order to identify at least one matching vendor profile from the plurality of vendor profiles; and
(I) assigning the matching vendor profile to the order request with the remote server, if the matching vendor profile is identified by the remote server, and if the matching vendor profile meets at least one specific system-wide rule set from the plurality of system-wide rule sets.

2. The method as claimed in claim 1 comprising the steps of:
providing the at least one matching vendor profile as a plurality of matching vendor profiles, wherein each matching vendor profile is ranked with a similarity rating based on the order request; and
assigning a first-highest-rated matching vendor profile to the order request with the remote server during step (I), if the first-highest-rated matching vendor profile meets the specific system-wide rule set, wherein the similarity rating of the first-highest-rated matching vendor is highest amongst the plurality of matching vendor profiles.

3. The method as claimed in claim 2 comprising the steps of:
providing each vendor profile with contact information;
sending an assignment request to the contact information of the first-highest-rated matching vendor profile with the remote server; and
assigning a second-highest-rated matching vendor profile to the order request with the remote server, if the assignment request is declined through the contact information of first-highest-rated matching vendor profile, and if the second-highest-rated matching vendor profile meets the specific system-wide rule set, wherein the similarity rating of the second-highest-rated matching vendor is second highest amongst the plurality of matching vendor profiles.

4. The method as claimed in claim 2 comprising the steps of:
sending an assignment request for the first-highest-rated matching vendor profile to the corresponding lender PC device; and
assigning a second-highest-rated matching vendor profile to the order request with the remote server, if the assignment request for the first-highest-rated matching vendor profile is declined by the lender account, and if the second-highest-rated matching vendor profile meets the specific system-wide rule set, wherein the similarity rating of the second-highest-rated matching vendor is second highest amongst the plurality of matching vendor profiles.

5. The method as claimed in claim 2 comprising the steps of:
sending an assignment request for the first-highest-rated matching vendor profile to the corresponding lender PC device;
assigning at least one lower-rated matching vendor profile to the order request with the remote server, if the assignment request for the first-highest-rated matching vendor profile is declined by the lender account, and if the lower-rated matching vendor profile meets the specific system-wide rule set, wherein the similarity rating of the lower-rated matching vendor is less than the similarity rating of the first-highest-rated matching vendor profile;
sending an assignment request for the lower-rated matching vendor profile to the corresponding lender PC device; and
assigning the first-highest-rated matching vendor profile to the order request with the remote server, if the assignment request for the lower-rated matching vendor profile is declined by the lender account, and if the first-highest-rated matching vendor profile meets the specific system-wide rule set.

6. The method as claimed in claim 1, wherein each exclusion rule is selected from a group consisting of: a lender-profile preference, a vendor status preference, and a service-related preference.

7. The method as claimed in claim 1, wherein each vendor filter is selected from a group consisting of: a location filter and a vendor-service filter.

8. The method as claimed in claim 1, each system-wide rule set is selected from a group consisting of: a rule set filter and a rule set criterion.

9. The method as claimed in claim 1 comprising the steps of:
comparing the specific exclusion rule to each vendor profile with the remote server during step (H) in order to identify a plurality of rule-meeting vendor profiles from the plurality of vendor profiles; and
comparing the specific vendor filter to each rule-meeting vendor profiles with the remote server during step (H) in order to identify the matching vendor profile from the plurality of rule-meeting vendor profiles.

10. The method as claimed in claim 1 comprising the steps of:
providing at least one administrator account managed by the remote server, wherein the administrator account is associated with a corresponding administrator PC device;
prompting the administrator account to select a specific system-wide rule set with the corresponding administrator PC device; and
relaying the specific system-wide rule set from the corresponding administrator PC device to the remote server.
